(19) United States
(12) Patent Application Publication
(10) Pub. No.: US 2008/0217086 A1
(43) Pub. Date: Sep. 11, 2008

(54) FIRE FIGHTING EQUIPMENT IN FOREST AREAS

(76) Inventor: Luiz Carlos Ferreira Neves, Estado de Sao Paulo (BR)

Correspondence Address: SUGHRUE MION, PLLC, 2100 PENNSYLVANIA AVENUE, N.W., SUITE 800, WASHINGTON, DC, 20037, US

(21) Appl. No.: 11/958,016

(22) Filed: Dec. 17, 2007

(30) Foreign Application Priority Data
Jan. 26, 2007 (BR) PI0700387

(51) Int. Cl. B62K 11/00

(52) U.S. Cl. 180/219

(57) ABSTRACT

The present invention refers to the technical sector of fire fighting equipments, where the mentioned equipment is constituted by a chassis (1) formed by a metallic structure, where in its rear portion a motorized wheel (2) is installed provided with a plurality of flaps (3) along its perimeter, whose movement is transmitted from a toothed crown (4) installed laterally on its shaft (5). The motorized force of the equipment is generated from an internal explosion engine (6) installed in the rear part of the chassis (1), where the mentioned engine (6) is provided with a shaft (7) whose end is equipped with a pulley (8) that transmits the movement to the pulley (9) installed on the command shaft (10) immediately above, by means of belt (11). The mentioned command shaft (10) is supported by the bearings (12) installed in the chassis (1), where in its intermediate region is provided with double pulley (13) that transmits movement through the belts (14) to the double pulley (15) installed on the shaft (16) of the reducer (17) in whose output is installed the gear (18) that in turn transmits the movement to the toothed wheel (4) and the stretching gear (19) through the toothed belt (20). The referred command shaft (10) is even provided with pulley (21) that transmits the movement through the belt (23) to the pulley (22) installed on the arm (24) of the rotor (25) that transmits torque to the chain (26) provided in each one of its links (27) of a welded plate (28) for undercutting, combing or weeding the land, where the mentioned rotor (25) is protected by the casing (29). The mentioned equipment on its upper part is provided with a headlight (34) for lighting of the trail, and of the handle commands (30) that through the cable (31) controls the rotation of the open link (27) chain (26).

The present invention patent deals with an original fire fighting equipment in forest areas, of innovative conception and equipped with important technological and functional improvements, according to the most modern engineering concepts and in accordance with the required norms and specifications, which is endowed with its own characteristics and fundamental requirements of novelty and inventive activity, resulting into a series of real and extraordinary technical, practical and economic advantages.

The present invention refers to the technical sector of fire fighting equipments.

As it is of knowledge of technicians on the matter, one of the major problems for the forest areas is maintaining them safe from fires, since it deals with a constant and eminent risk mainly in the driest time of the year.

From international news, information of entire forests burned is received and without the minimum chance of control due to the difficulty of making clearings or of access to the site by means of trucks or machines.

In the case of forest companies, noticeably the Brazilian forests are no different, many of them lose entire plantation fields due to lack of means of controlling the flames that are propagated differently in function of the climatic and local relief conditions.

The state of the technique of the present patent can be understood by the following patent documents, among which BRPI9801957-0 is highlighted that shows a plastic bomb for forest fire fighting, which does not cause damages to nature since it is biodegradable and its fuel is water, which can be used for pouring with airplane or helicopter, such that, in order to be poured from an airplane it should be housed in bucket type cages with internal pole for the bombs to be hung and to facilitate loading, and posterior storage, and its use for helicopter, pail or scoop type cages should be used also with internal pole to make its loading easier and using the least number of people; the bucket, pail or scoop type cage accessories are parts that will be preformed according to the type of aircraft to be used, which can be Buffalo, Hercules, C-130, B-52 type plane even in military helicopters. As it can be seen, the inherent technical problem of this type of product is the high operation cost, since it needs airplanes or helicopters.

The patent document BRMU8301128-5 deals with a mobile fire fighting equipment in forest areas and other sites where access is possible by airway permits the use of cargo aircrafts with rear doors in forest fire fighting, besides expanding the range of aircrafts that can be employed in such activity and reducing investment and operating costs, provides the obtainment of better results, due to alternatives of variation of water volume to be poured per area, as well as the flow to be oriented horizontally and in perpendicular to the length of the airplane's fuselage. The mentioned equipment is composed of a main tank for the water, a secondary tank for the chemical additives, a reclining duct for orientation of flow, regulating pressure and flow valves and a tank of compressed air, with the respective compressor. As it can be seen, in the same way as the previous document, the inherent technical problem of this type of product is the high operation cost, since it needs airplanes or helicopters.

The document BRPI9104953-9 deals with a process for forest fire fighting, which uses aircrafts that, by passing through foci or lines of fire, bombard with water or chemical products, at low height in the longitudinal direction of the line of fire, above the vegetation, until it forms a humid, non-propagating, incombustible strip (Life Line), forming a natural barrier to the fire, permitting its control and extinction. In general lines, the invention includes aircrafts with tank, which supposes ventral hood or complement, sprinkler or valve, where an assembly is prepared for activation. As it can be seen, in the same way as the previous document, the inherent technical problem of this type of product is the high operation cost, since it needs aircrafts to reach the fire fighting objective.

The document BRPI 9804452-4 deals with a fire fighting equipment in forest fires, which includes, basically and essentially, a vessel, compressed volume gas container, which is surrounded by a chamber, suitable for expansion of the gases of the vessel, through the operation of the valve; such that, the vessel, as well as the chamber, are concentrically positioned inside a tank containing the combustion inhibiting product, which could be provided with weak points in its structure, in order to aid in its disintegration. As it can be observed, this equipment is also burdensome as it is composed of a compressed volume gas tank, which is even surrounded by a chamber.

In view of this, in the course of time studies were carried out aiming to minimize these problems and inconveniences and, as consequence, this assembly was developed that permitted the conception of an original fire fighting equipment in forest areas.

This developed and tested equipment is important exactly for making the clearing and providing the control of fires even in areas with accentuated slope or with difficult access, thus preventing the fire to be scattered and to provoke major losses.

### OBJECTIVES

To control fires rapidly, safely and economically viable.

Development

This equipment is self-propelling handlebar and of great aid to fire fighting, which has the following characteristics:

Functions

Undercutting, Combing, Weeding and subduing the fire through the projection of sandy particles released from the land through friction with it.

Objective: Forest fire fighting, forest protection through clearings.

Safety System

The commands are activated by the operator and without this contact the entire system stops, such that there is no hazard of lack of control on the part of the lockings. The operator stays protected by using individual protective equipments—IPE's, preventing soil particles to come to represent any risk.

Operation

The equipment is versatile, light and reliable, which can be used in the most diverse types of land and vegetation.

The displacement and the direction of the assembly take place by motor. The metallic wheels with claws provide stability and assurance of circulation through lands where the action of the fire has already propagated (burned), without damaging the assembly. The main mission of the equipment (functions of undercutting, combing, weeding and subduing the fire) takes place through the rotation of an axial shaft, driven by a gasoline motor.

Destination

It is destined for fire fighting through the manufacture of clearings, preventing the forest fire to be proliferated through greater extents destroying the actual vegetation.

The proposed innovation in the present invention patent concerns a fire fighting equipment in forest areas conceived with important technological and functional improvements, which refers most accurately to the integration procedure of a chassis formed by a metallic structure, where in its rear portion a motorized wheel is installed provided with a plurality of flaps along its perimeter, whose movement is transmitted from a toothed crown installed laterally on its shaft.

The motorized force of the equipment is generated from an internal explosion engine installed in the rear part of the chassis, where the mentioned engine is provided with a shaft whose end is equipped with a pulley that transmits the movement to the pulley installed on the command shaft immediately above, by means of belt.

The mentioned command shaft is supported by the bearings installed in the chassis, where in its intermediate region is provided with double pulley that transmits movement through the belts to the double pulley installed on the shaft of the reducer in whose output is installed the gear that in turn transmits the movement to the toothed wheel and the stretching gear through the toothed belt.

The referred command shaft is even provided with pulley that transmits the movement through the belt to the pulley installed on the arm of the rotor that transmits torque to the chain provided in each one of its links of a welded plate for undercutting, combing or weeding the land, where the mentioned rotor is protected by the casing.

The mentioned equipment on its upper part is provided with a headlight for lighting of the trail, and of the handle commands that through the cable controls the rotation of the open link chain.

The movement of the equipment is controlled by the control stick interlinked to the reducer through the cable.

On the front part, the mentioned equipment is provided with cylindrical guide wheel and on the rear part with two shock absorbers to stabilize the assembly.

In this way, it adds other more technical, practical and functional advantages, bestowing on the product greater robustness, an ideal possibility for meeting the needs of operation and installation, valuing the cost/benefit function and competing to offer solutions of greater free physical space and easy maintenance.

So that a clear visualization of the fire fighting equipment in forest areas in question may be obtained, the attached illustrative designs are included, to which references are made in order to better elucidate the detailed description that follows:

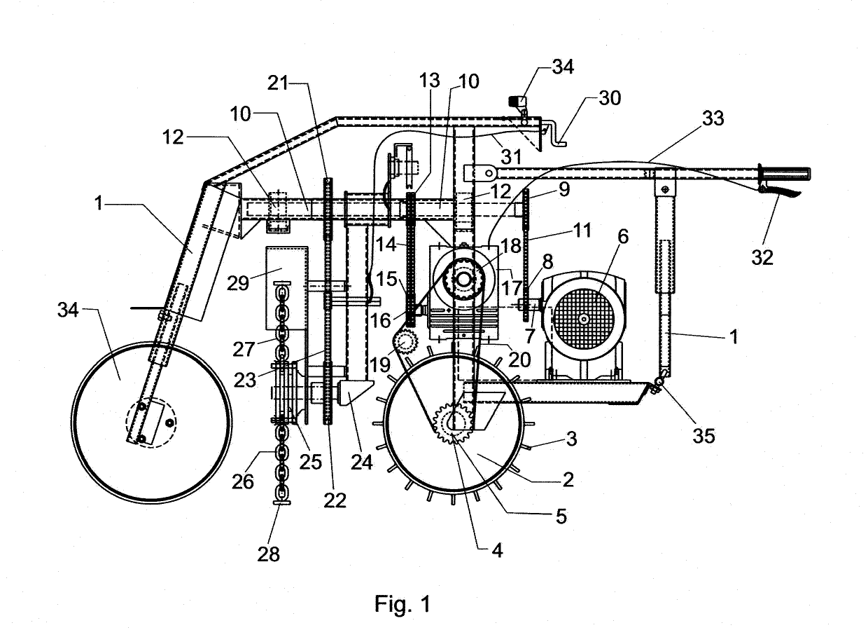

FIG. 1 represents the view in elevation of the mounted assembly;

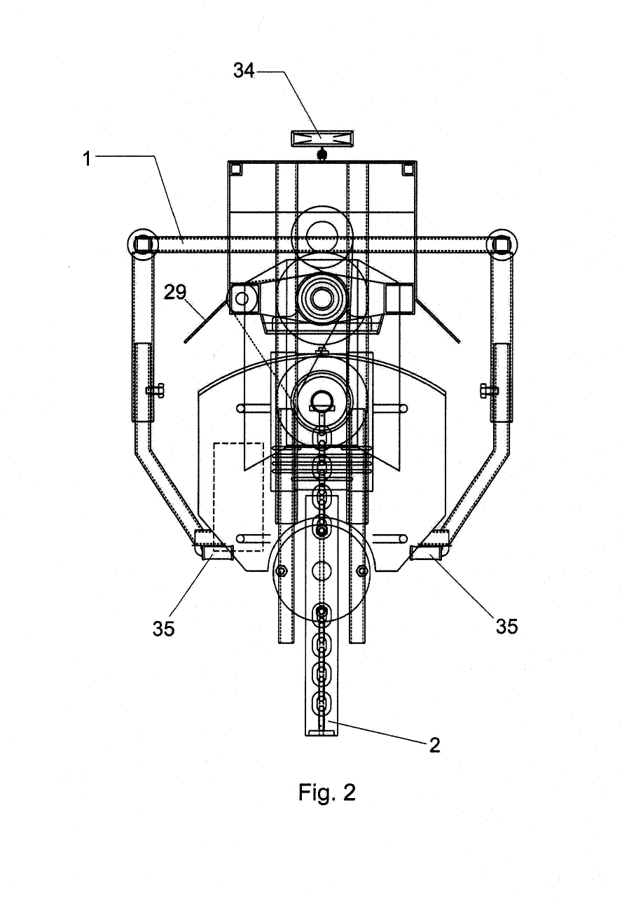

FIG. 2 represents the view in profile of the mounted assembly;

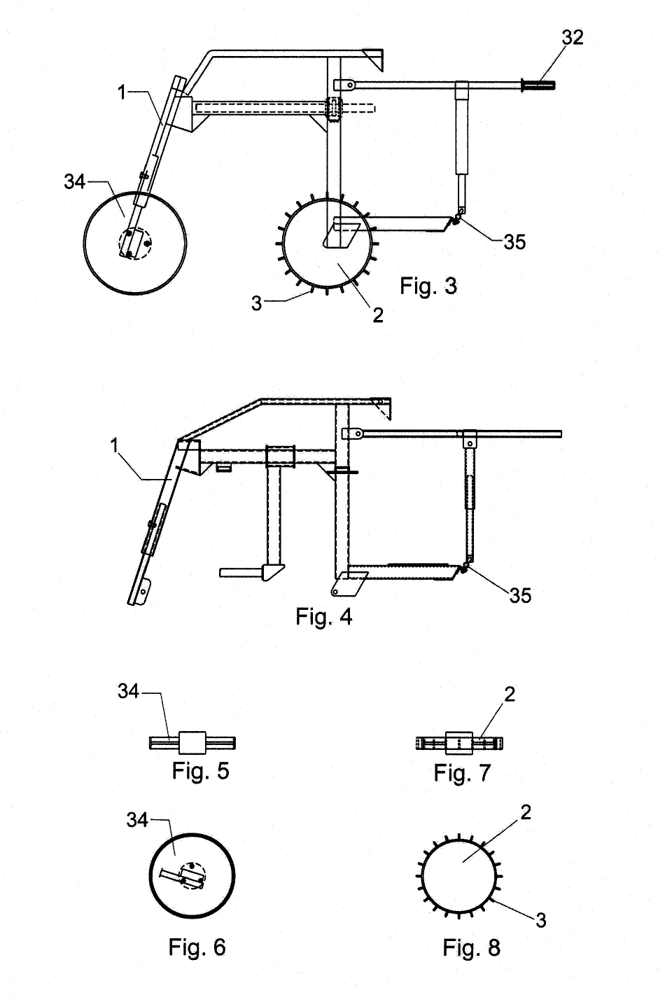

FIG. 3 represents a view in elevation of the chassis only with the smooth frontal wheel and the rear motorized wheel both positioned;

FIG. 4 represents the view in elevation of the chassis;

FIG. 5 represents a floor view of the smooth frontal wheel;

FIG. 6 represents a view in elevation of the smooth frontal wheel;

FIG. 7 represents a floor view of the rear motorized wheel;

FIG. 8 represents a view in elevation of the rear motorized wheel;

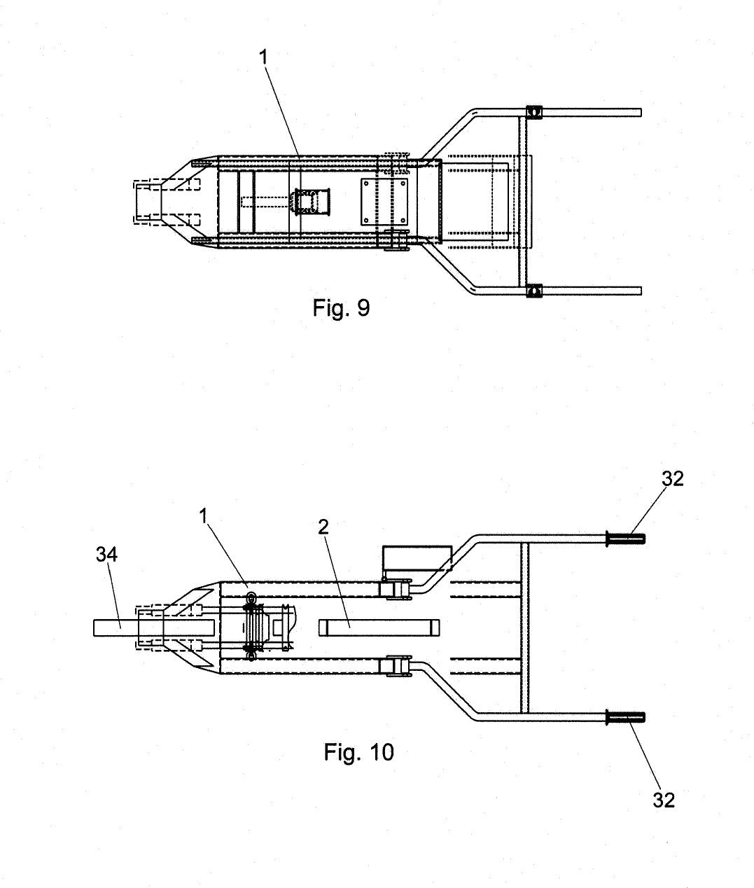

FIG. 9 represents the floor view of the chassis;

FIG. 10 represents another floor view of the chassis.

In accordance with these illustrations and their details, the fire fighting equipment in forest areas is constituted by a chassis (1) formed by a metallic structure, where in its rear portion a motorized wheel (2) is installed provided with a plurality of flaps (3) along its perimeter, whose movement is transmitted from a toothed crown (4) installed laterally on its shaft (5).

The motorized force of the equipment is generated from an internal explosion engine (6) installed in the rear part of the chassis (1), where the mentioned engine (6) is provided with a shaft (7) whose end is equipped with a pulley (8) that transmits the movement to the pulley (9) installed on the command shaft (10) immediately above, by means of belt (11).

The mentioned command shaft (10) is supported by the bearings (12) installed in the chassis (1), where in its intermediate region is provided with double pulley (13) that transmits movement through the belts (14) to the double pulley (15) installed on the shaft (16) of the reducer (17) in whose output is installed the gear (18) that in turn transmits the movement to the toothed wheel (4) and the stretching gear (19) through the toothed belt (20).

The referred command shaft (10) is even provided with pulley (21) that transmits the movement through the belt (23) to the pulley (22) installed on the arm (24) of the rotor (25) that transmits torque to the chain (26) provided in each one of its links (27) of a welded plate (28) for undercutting, combing or weeding the land, where the mentioned rotor (25) is protected by the casing (29).

The mentioned equipment on its upper part is provided with a headlight (34) for lighting of the trail, and of the handle commands (30) that through the cable (31) controls the rotation of the open link (27) chain (26).

The movement of the equipment is controlled by the control stick (32) interlinked to the reducer (6) through the cable (33).

On the front part, the mentioned equipment is provided with cylindrical guide wheel (34) and on the rear part with two shock absorbers (35) to stabilize the assembly.

There is no knowledge of any fire fighting equipment in forest areas that gathers together, all constructive and functional characteristics reported above, and that directly or indirectly, is or was so effective as the equipment object of the present patent.

It deals, therefore, with an assembly of great importance for the intended purpose, which consist of an original way of obtaining a fire fighting equipment in forest areas, satisfying fully the proposed objectives and fulfilling practically and efficiently the intended functions, providing a series of advantages inherent to its applicability, being endowed with its own, innovative characteristics and equipped with fundamental requirements of novelty and inventive activity, demanded to deserve the invention patent protection.

1. “FIRE FIGHTING EQUIPMENT IN FOREST AREAS”, characterized by the fact that it is constituted by a chassis (1) formed by a metallic structure, where in its rear portion a motorized wheel (2) is installed provided with a plurality of flaps (3) along its perimeter, whose movement is transmitted from a toothed crown (4) installed laterally on its shaft (5);

2. “FIRE FIGHTING EQUIPMENT IN FOREST AREAS”, characterized by the fact that the motorized force of the equipment is generated from an internal explosion engine (6) installed in the rear part of the chassis (1), where the mentioned engine (6) is provided with a shaft (7) whose end is equipped with a pulley (8) that transmits the movement to the pulley (9) installed on the command shaft (10) immediately above, by means of belt (11);

3. “FIRE FIGHTING EQUIPMENT IN FOREST AREAS”, characterized by the fact that the mentioned command shaft (10) is supported by the bearings (12) installed in the chassis (1), where in its intermediate region is provided with double pulley (13) that transmits movement through the belts (14) to the double pulley (15) installed on the shaft (16) of the reducer (17) in whose output is installed the gear (18) that in turn transmits the movement to the toothed wheel (4) and the stretching gear (19) through the toothed belt (20);

4. “FIRE FIGHTING EQUIPMENT IN FOREST AREAS”, characterized by the fact that the referred command shaft (10) is even provided with pulley (21) that transmits the movement through the belt (23) to the pulley (22) installed on the arm (24) of the rotor (25) that transmits torque to the chain (26) provided in each one of its links (27) of a welded plate (28) for undercutting, combing or weeding the land, where the mentioned rotor (25) is protected by the casing (29);

5. “FIRE FIGHTING EQUIPMENT IN FOREST AREAS”, characterized by the fact that the referred equipment in its upper part is provided with a headlight (34) for lighting of the train, and of the handle commands (30) that through the cable (31) controls the rotation of the open link (27) chain (26), where the movement of the equipment is controlled by the control stick (32) interlinked to the reducer (6) through the cable (33);

6. “FIRE FIGHTING EQUIPMENT IN FOREST AREAS”, characterized by the fact that on the frontal part, the mentioned equipment is provided with a cylindrical guide wheel (34) and on the rear part with two shock absorbers (35) to stabilize the assembly.
